(19) United States
(12) Patent Application Publication
(10) Pub. No.: US 2012/0274147 A1
(43) Pub. Date: Nov. 1, 2012

(54) WIRELESS ENERGY TRANSMISSION USING NEAR-FIELD ENERGY

(75) Inventors: Frederick P. Stecher, Corcoran, MN (US); Christopher Fuller, Bloomington, MN (US)

(73) Assignee: ALLIANT TECHSYSTEMS INC., Minneapolis, MN (US)

(21) Appl. No.: 13/276,754

(22) Filed: Oct. 19, 2011

Related U.S. Application Data
(60) Provisional application No. 61/480,210, filed on Apr. 28, 2011.

(51) Int. Cl. H01F 38/14

(52) U.S. Cl. 307/104

(57) ABSTRACT

Techniques are described for wireless energy transmission and projecting magnetic fields over relatively long near-fields. In one example, a device for transmitting near-field energy comprises at least one source that generates a radiofrequency (RF) signal, an antenna that generates near-field signals from the RF signal, and a plurality of sub-wavelength sized elements that form a lens in communication with the antenna that captures the near-field signals, generates near-field energy, and re-directs the near-field energy toward an object in the near-field of the lens, where the sub-wavelength sized elements are disposed about the antenna.

### CROSS-REFERENCE TO RELATED APPLICATIONS

This application claims the benefit of U.S. Provisional Application No. 61/480,210, entitled, “WIRELESS ENERGY TRANSMISSION USING NEAR-FIELD SUB-WAVELENGTH ENERGY,” by Frederick P. Stecher and Christopher Fuller, and filed on Apr. 28, 2011, the entire contents of which being incorporated herein by reference.

### TECHNICAL FIELD

The disclosure relates to energy transmission and, more particularly, to wireless energy transmission.

### BACKGROUND

In general, electrical energy is transmitted from one point to another via overhead or underground transmission lines. Overhead transmission lines require large transmission towers or other structures for support. Underground transmission lines are generally more expensive than overhead transmission lines, due to the costs associated with the insulated cable and its burial. In addition to their associated costs and infrastructure, installation of overhead and underground transmission lines is time consuming.

### SUMMARY

In general, this disclosure describes techniques for coherent electro-magnetic/magnetic field generation and wireless energy transmission. The techniques include wirelessly transmitting energy, e.g., from one or more tower transmitters, to one or more targets or objects, as well as projecting magnetic fields over relatively long near-field distance. In some examples, the objects are remote receivers that are configured to receive the transmitted energy. In one example, one or more transmitters are mounted on each tower. Each transmitter includes an antenna and a lens comprised of sub-wavelength sized elements disposed about the antenna for producing a near-field focused energy beam that is transmitted to a remote receiver.

In one example, this disclosure is directed to a device for transmitting near-field energy. The device comprises at least one source that generates a radio frequency (RF) signal, an antenna that generates near-field signals from the RF signal, and a plurality of sub-wavelength sized elements that form a lens in communication with the antenna that captures the near-field signals, generates near-field energy, and re-directs the near-field energy toward an object in the near-field of the lens, wherein the sub-wavelength sized elements are disposed about the antenna.

In another example, this disclosure is directed to a device for receiving near-field energy, the device comprising a plurality of sub-wavelength sized elements forming a lens that captures the near-field energy, and an antenna in communication with the lens that generates a current from the near-field energy, wherein the sub-wavelength sized elements are disposed about the antenna.

In another example, this disclosure is directed to a system for wirelessly transmitting near-field energy. The system comprises at least one source that generates a radiofrequency (RF) signal, a first antenna that generates near-field signals from the RF signal, a first plurality of sub-wavelength sized elements that form a first lens in communication with the antenna that captures the near-field signals, generates near-field energy, and re-directs the near-field energy into the near-field of the first lens, wherein the first plurality of sub-wavelength sized elements are disposed about the first antenna. The system further comprises a second plurality of sub-wavelength sized elements that form a second lens that captures the transmitted near-field energy, and a second antenna in communication with the second lens that generates a current from the near-field energy, wherein the second plurality of sub-wavelength sized elements are disposed about the second antenna.

In another example, this disclosure is directed to a directed energy weapon that transmits near-field energy. The weapon comprises a source that generates a radiofrequency (RF) signal, an antenna that generates near-field signals from the RF signal, and a plurality of sub-wavelength sized elements forming a lens in communication with the antenna that captures the near-field signals, generates near-field energy, and re-directs the near-field energy toward a target in the near-field of the lens, wherein the plurality of sub-wavelength sized elements are disposed about the antenna.

In another example, this disclosure is directed to a method of transmitting near-field energy. The method comprises generating a radiofrequency (RF) signal, generating, via an antenna, near-field signals from the RF signal, capturing, via a near-field lens comprising sub-wavelength sized elements disposed about the antenna, the near-field signals, and generating near-field energy and re-directing the near-field energy toward an object in the near-field of the lens

The details of one or more aspects of the disclosure are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example wireless energy transmission system in accordance with various techniques of this disclosure.

FIG. 2 is a conceptual diagram illustrating another example wireless energy transmission system in accordance with various techniques of this disclosure.

FIG. 3 is a block diagram illustrating various example components of a transceiver for use in a wireless energy transmission and/or reception system, in accordance with this disclosure.

FIGS. 4A and 4B are three dimensional illustrations of example composite elements that may be used as sub-wavelength sized elements to implement various techniques described in this disclosure.

FIG. 5 is a top view of an example lens and antenna that may be used to implement various techniques of this disclosure.

FIG. 6 is an example sub-wavelength sized element that may be used to implement various techniques of this disclosure.

FIG. 7 is a conceptual diagram illustrating a perspective cross-sectional view of an example near-field lens formed of sub-wavelength sized elements, in accordance with various techniques of this disclosure.

FIG. 8 depicts an example system for wirelessly transmitting near-field energy, in accordance with this disclosure.

FIG. 9 is a block diagram illustrating an example directed energy weapon using various techniques of this disclosure.

FIG. 10 is a block diagram illustrating an example electro-magnetic deflection system using various techniques of this disclosure.

FIG. 11 depicts an example system for remotely powering a vehicle using various techniques of this disclosure.

FIG. 12 depicts an example system for remotely powering one or more systems using various techniques of this disclosure.

FIG. 13 depicts an example magnetic levitation module for lifting and/or propelling vehicles or objects using various techniques of this disclosure.

FIG. 14 depicts an example magnetic levitation system for lifting and/or propelling vehicles using various techniques of this disclosure.

FIG. 15 depicts an example system for producing an artificial magnetosphere using various techniques of this disclosure.

FIG. 16 depicts an example system for providing inter-satellite and space-based power using various techniques of this disclosure.

FIG. 17 depicts an example wireless power extension system using various techniques of this disclosure.

FIG. 18 depicts an example wireless power temporary hookup system using various techniques of this disclosure.

FIG. 19 depicts an example wireless power replacement system using various techniques of this disclosure.

### DETAILED DESCRIPTION

This disclosure describes techniques for wireless electric energy transmission. Using various techniques of this disclosure, low frequency, e.g., 1 kilohertz (kHz), radio frequency (RF) energy beams can be transmitted wirelessly over long ranges, e.g., 300 kilometers (km). As described in more detail below, a transmitter utilizing an antenna and lens comprising sub-wavelength sized elements generate, focus, and project near-field energy toward a target or a remote receiver. A sub-wavelength sized element is an object whose physical dimensions are less than the size of the wavelength generated by the antenna and source. Sub-wavelength sized elements include composite elements having high-permeability and/or high-permittivity and/or metamaterial elements, as described in more detail below. The receiver, which includes a similar antenna and lens comprising sub-wavelength sized elements, receives the near-field energy and converts the energy to either alternating current or direct current for use by a user that is electrically connected to the remote receiver, e.g., via a service panel on the receiver.

Near-field energy dissipates on lossy objects and is detectable up to about one wavelength way from its source. Unlike far-field radio waves, near-field radio waves do not depart from the antenna. As such, there is little or no radiation of power. So, any transmitted near-field energy that is not picked up by the receiver does not continue onward and cause damage and is therefore safer than far-field energy.

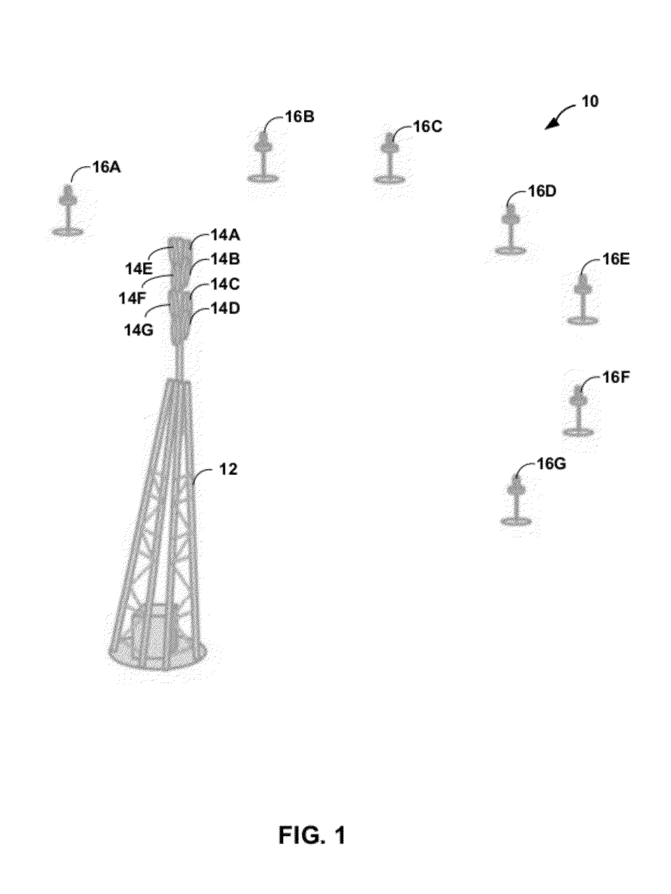

FIG. 1 is a conceptual diagram illustrating an example wireless energy transmission system in accordance with various techniques of this disclosure. In particular, FIG. 1 depicts wireless energy transmission system 10 having transmission tower 12, a plurality of transmitters 14A-14G (collectively referred to herein as “transmitters 14”) supported by tower 12, and one or more objects, e.g., remote receivers 16A-16G (collectively referred to herein as “receivers 16”), that receive the wireless energy transmitted by one or more of transmitters 14. Such a configuration provides remote power via transmission tower 12.

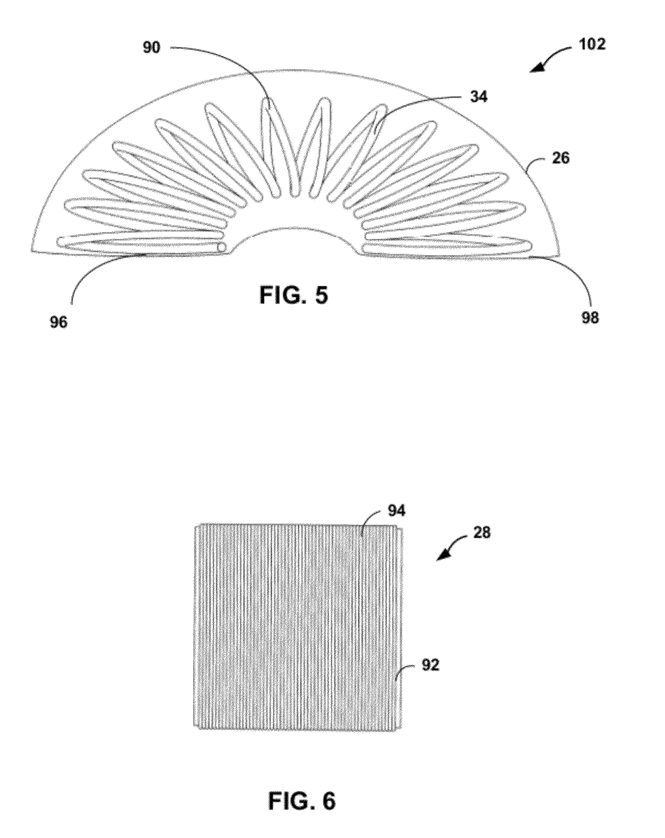

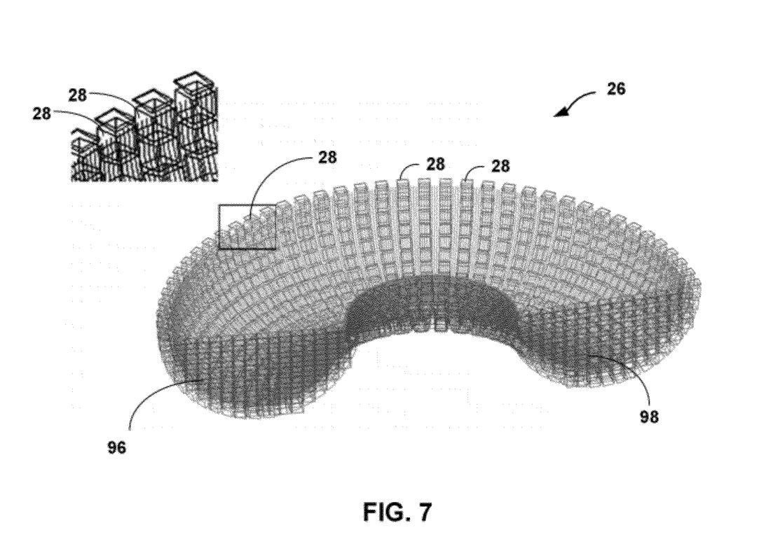

In some example configurations, each transmitter 14 includes a directional antenna aligned with a respective one of remote receivers 16. Transmitters 14 are connected to an onsite electric power source. In one example implementation, the electric power source may be a fuel cell, e.g., a solid oxide fuel cell available from Bloom Energy of Sunnyvale, Calif. In other examples, the power source may be a diesel generator, a central power plant, or energy beamed from space. Each of transmitters 14 convert either alternating current or direct current from the power source into low frequency near-field RF signals that are beamed by a near-field RF lens to a respective receiver 16. Near-field lenses that may use the techniques in FIG. 1 are shown and described in more detail below. One example configuration of a near-field lens is shown and described below with respect to FIGS. 5 and 7.

In another example, system 10 may use a phased array configuration. In such a configuration there may be one transmitter 14 and a plurality of receivers 16.

In some examples, the near-field RF lens utilizes metamaterial elements. Lenses that utilize sub-wavelength sized elements and transmitters that utilize such lens are described in detail U.S. Pat. No. 7,928,900, entitled “Improved Resolution Radar Using Metamaterials, by Fuller et al., and incorporated by reference herein in its entirety. In other examples, the near-field RF lens utilizes composite materials, as described in detail below. In another example, the near-field RF lens utilizes both composite materials and metamaterials.

Each receiver 16 includes a low frequency near-field RF lens to receive the near-field RF signal from respective transmitter 14. The received near-field RF signal is converted, via an antenna in communication with the lens, to either direct or alternating electrical current which is directed into an electrical panel or directly into electrical device or into storage at a utilization site facility associated with the receiver (not depicted).

In another example implementation (not depicted), each transmission tower 12 relays modulated communication RF signals to each receiver 16. Each receiver 16 includes an antenna that uses the low frequency near field RF lens and also accesses the modulated communication RF signals. The received near-field RF signals are converted to either direct or alternating electrical current which is directed into an electrical panel or directly into electrical device or into storage at a utilization site facility associated with the receiver. The modulated communication signal is broadcast throughout the facility. In some examples, transmission tower 12 may vary the frequency of the carrier in order to provide power to loads with varying power requirements. In addition, customers can be assigned a particular frequency and transmission tower 12 may vary the frequency of the signals in order to deliver signals to various customers.

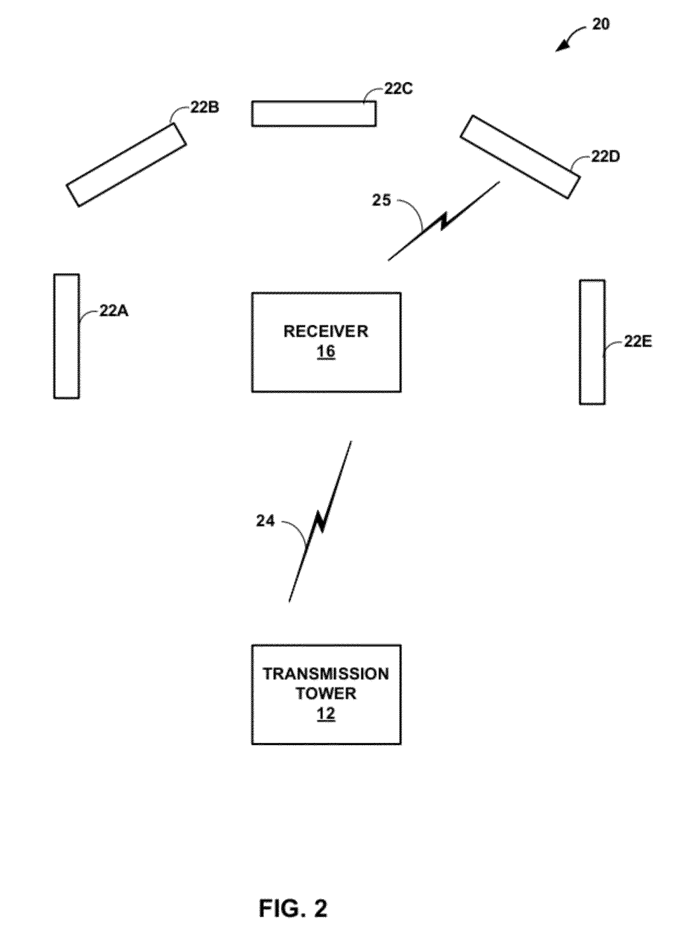

FIG. 2 is a conceptual diagram illustrating another example wireless energy transmission system in accordance with various techniques of this disclosure. In particular, FIG. 2 depicts an example wireless energy transmission system that may be used to deliver or provide backup power to remote locations. System 20 includes transmission tower 12, similar to transmission tower 12 of FIG. 1, as well as one or more remote receivers 16, similar to remote receivers 16A-16G of FIG. 1. Remote receiver 16 provides backup power to a remote location that includes sub-regions 22A-22E (collectively referred to herein as “sub-regions 22”).

Equipment at transmission tower 12, or another central facility, monitors the power at each sub-region 22. When there is a power outage in one or more sub-regions 22, e.g., sub-region 22D, transmission tower 12 transmits near-field RF power 24 to remote receiver 16. Remote receiver 16 relays RF power 25 to one or more receivers (not depicted) in sub-region 22D. If sub-region 22D is in line of sight of transmission tower 12, then transmission tower 12 transmits near-field RF power 24 directly to sub-region 22D. In other examples, rather than relay power through receiver 16, transmission tower 12 transmits near-field RF power directly to one or more sub-regions 22.

Although system 20 in FIG. 2 was described above with respect to providing backup power, in some example implementations, system 20 may be the primary source of power for one or more sub-regions 22. That is, rather than provide power to one or more sub-regions 22 via transmission lines, using the techniques of this disclosure, near-field energy may be transmitted to the sub-region through the air without the need for transmission cables.

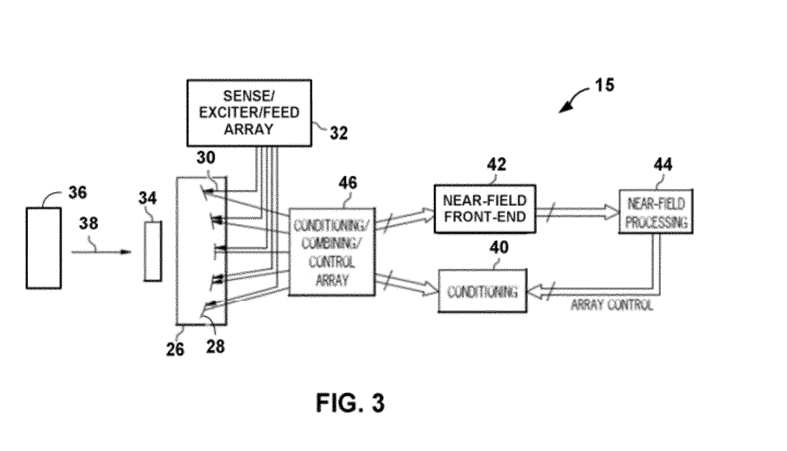

FIG. 3 is a block diagram illustrating various example components of a transceiver for use in a wireless energy transmission and/or reception system, in accordance with this disclosure. Transceiver 15 of FIG. 3 transmits and/or receives near-field energy, thereby performing the functions described above with respect to transmitter 14 and/or receiver 16. In FIG. 3, transceiver 15 includes near-field lens 26 that includes a plurality of sub-wavelength sized lens elements 28, e.g., using composite materials or metamaterials.

One way to create a metamaterial sub-wavelength sized element is by using dielectric resonators. Dielectric resonators can resonate in various transverse modes, including Transverse Magnetic modes (“TM,” no magnetic field in the direction of propagation), Transverse Electric modes (“TE,” no electric filed in the direction of propagation), or Transverse ElectroMagnetic modes (“TEM,” neither electric nor magnetic fields in the direction of propagation). When the dielectric resonators are resonant in TM or TE modes then only one effective negative dielectric property (permittivity or permeability) is provided by the resonator so the other effective negative dielectric property is provided by a resonant mode occurring in the spacing between dielectric resonators. For cube shaped dielectric resonators, the third mode/resonance of the cube is usually a TEM mode, so that both negative permittivity and negative permeability are provided. More information may be found in “Application of Cubic High Dielectric Resonator Metamaterial to Antennas,” by Jaewon Kim and Anand Gopinath, presented in session 220 at IEEE Antenna and Propagation Society conference in June 2007, the entire content of which being incorporated herein by reference.

High permeability and high permittivity materials may be combined into one resonator cube lens for TEM mode resonance within the cube. For situations in which the dielectric resonator provides a first resonant mode and the gap between resonators provides the second resonant mode, using high permittivity material in resonator and then using high permeability material in the gap, or vice versa, the size of the resonator elements may be dramatically reduced. Furthermore, efficiency is maintained in such a design by matching the wave impedance closely to free space or to the media the resonator elements are contained within. By using high permittivity materials combined with high permeability materials, efficient negative permeability and permittivity are achieved using one cube in which the separation between cubes is not critical. The benefits of a cube resonator are that they are low-loss compared to metallic elements, they may be designed to provide an isotropic response which simplifies resonator array and lens designs in some cases and size reduction features are built in by alternating materials with high relative permittivity (dielectric) and relative permeability constants. Also, high permittivity materials may be combined with artificial high permeability materials using a resonant approach in order to eliminate saturation of natural high permeability materials.

In addition, transceiver 15 may include one or more near-field stimulators 30. In some examples, individual control of some or all of the sub-wavelength sized elements is desirable in order to provide more control over the lens. FIG. 3 depicts each sub-wavelength sized lens element 28 in communication with a near-field stimulator 30. Each near-field stimulator 30 may be, for example, a near-field probe, a port, an antenna, or combination thereof. The near-field probes are used to stimulate (in an unmodulated or modulated manner) signals that would be utilized by sub-wavelength sized elements 28 to produce a near-field energy beam. As shown in the example of FIG. 3, each near-field stimulator 30 is aligned with a sub-wavelength sized element 28 and in operative communication with a sense/exciter/feed array 32.

Transceiver 15 further includes antenna 34. It should be noted that the term antenna could also be taken as meaning an antenna array. In accordance with the techniques of this disclosure, lens 26 is disposed about, e.g., surrounds, antenna 34. Antenna 34 is used to stimulate the sub-wavelength sized elements 28 of near-field lens 26 to produce near-field signals for transmission. In some example implementations, both antenna 34 and near-field stimulators 30 may be used to stimulate the sub-wavelength sized elements 28 of near-field lens 26 to produce near-field signals. In other example implementations, near-field stimulators 30 may be used instead of antenna 34 to stimulate sub-wavelength sized elements 28. In such examples, lens 26 is disposed about, e.g., surrounds, near-field stimulators 30.

In the example configuration depicted in FIG. 3, in order to receive a near-field energy beam, source 36, e.g., a power source and RF signal generator, generates RF wave 38, which stimulates the sub-wavelength sized elements. For reception of a near-field energy beam via one or both of antenna 34 and near-field stimulators 30, source 36 induces a signal into sense/exciter/feed array 32, which stimulates sub-wavelength sized elements 28 of near-field lens 26 to produce near-field signals, resulting in an efficient near-field energy beam for optional reception by antenna 34, and/or conditioning/combining/control array stage 46. In some example configurations, multiple antennas 34 and multiple near-field lenses 26 may be used to receive near-field energy. It should be noted that transceiver 15 may be operated with any combination of sense/exciter/feed array 32, conditioning/combining/control array 46, near-field front-end 42, conditioning 40, near-field processing 44, near-field stimulators 30 and source 36. It should be further noted that the connection between source 36 and antenna 34 may be either a physical electrical connection, e.g., wired, or an electrical connection via fields.

In some example configurations, transceiver 15 also includes at least one, or a combination of, components or circuits which perform the following: near-field conditioning 40, near-field RF front-end 42, and near-field processing 44 in order to produce an optimum near-field energy beam for transmission to receivers 16 or reception from transmitters 14. The transmitter aspect of transceiver 15, e.g., the aspect described above with respect to transmitters 14, may include sense/exciter/feed array 32, near-field conditioning 40, and near-field processing 44 and the receiver aspect of transceiver 15, e.g., the aspect described above with respect to receivers 16, includes near-field RF front-end 42, near-field conditioning 40, and near-field processing 44. It should be noted that for fixed-range applications, all of the components described above may not be required.

Near-field conditioning 40 and near-field processing 44 control the focal point of lens 26 during transmit and receive by detecting variability in supply voltages and the like. Near-field RF front-end 42 is used to combine, synchronize (for pulsed systems), and convert the RF frequencies received into signals at lower frequencies that can be processed more readily by a signal processor and/or other analog and digital circuitry. For low frequencies, e.g., about 1 kHz, the conversion can be performed directly by the sub-wavelength sized array, signal processor, or other analog and digital circuitry. Near-field processing refers to analog or digital signal processing, which is well-known by those skilled in the art. It should be noted that the front-end stage may also form part of a circuit for receiving transmitted near-field energy.

In some example implementations, transceiver 15 includes circuitry in communication with the sub-wavelength sized transmit array that is designed as a conditioning/combining/control array stage 46. Conditioning/combining/control array stage 46 detects the near field signals from a near-field probe, high impedance probe, or other type of contact probe. It may also be used for stimulating sub-wavelength sized elements using a near-field probe. Also, conditioning/combining/control array stage 46 can be used for steering the angle, beamwidth, bandwidth, center frequency, modulation, squint, polarization, EH phase (E and H are the components, where E=electric and H=magnetic), focus of the main beam of the sub-wavelength sized element array for reception or transmission via the use of ports or probes or a separate antenna or other antenna array. It may provide the appropriate signals to the antenna or antenna array. It may control the center frequency, bandwidth and/or possibly the order of the sub-wavelength sized element filter by the use of tuning elements such as varactors, gyrators, pin diode switched elements, load/impedance pull, saturable magnetics, modulation/frequency control, or other tunable resonator components or sub-circuits, or a combination thereof. And, it may be used for optimizing power transfer between sensing/stimulating arrays and the control circuitry.

Transceiver 15 may, in some examples, be used in a phased array configuration. In such a configuration, transceiver 15 may focus and transmit near-field energy at various targets or receivers in order to maximize efficient power transfer. The near-field energy may, in some examples, be received by a phase-array receiver.

As indicated above, sub-wavelength sized elements such as composite elements and/or metamaterial elements may be used to implement various techniques described in this disclosure. Traditional metamaterial techniques generally refer to using sub-wavelength sized resonators to achieve effective relative permittivity=effective relative permeability=−1. Composite elements, however, may utilize combinations of natural and artificial materials in order to create high relative permittivity (e.g., >9) and/or high relative permeability (e.g., >9), materials. Use of composite materials may be desirable to minimize discontinuities in the radio-waves, reduce side lobes, and/or reduce the size of the lens.

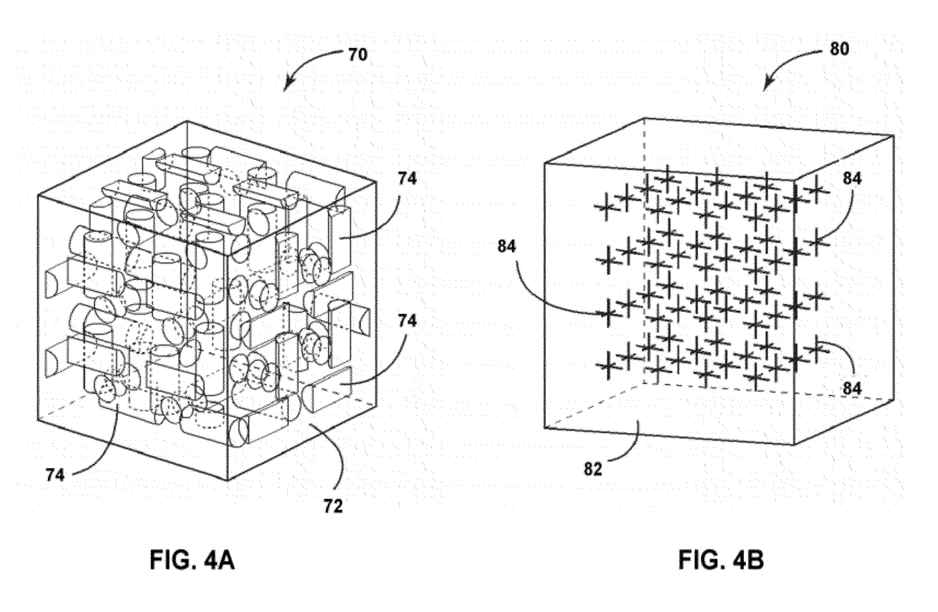

FIGS. 4A and 4B are three dimensional illustrations of example composite elements that may be used as sub-wavelength sized elements to implement various techniques described in this disclosure. The composite material includes interstitial material that has at least one of a select relative permittivity property value and a select relative permeability property's value. The composite material further includes inclusion material within the interstitial material. The inclusion material has at least one of a select relative permeability property value and a select relative permittivity property value. The select relative permeability and permittivity property values of the interstitial and the inclusion materials are selected so that the effective intrinsic impedance of the composite material matches the intrinsic impedance of air at the frequencies of interest.

Referring to FIG. 4A, one example composite material 70 is illustrated. Composite material 70 includes interstitial material 72 that has a select relative permittivity property value and inclusions 74 that have a select relative permeability property value. Examples of high relative permittivity (∈ᵣ) material used for the interstitial material include, but are not limited to, Teflon (∈ᵣ=2.1) or NP0 with an ∈ᵣ of about 100, or X7R (http://www.johansondielectrics.com/technical-notes/product-training/basics-of-ceramic-chip-capacitors.html) with ∈ᵣ>2000 or Y5V with ∈ᵣ>15,000. Examples of relatively high permeability (μᵣ) material used for inclusions include, but are not limited to, Z-phase hexaferrites having ∈ᵣ=μᵣ=12. G4256 with a μᵣ of about 100 and ferrite or other materials with μᵣ>1000. In some examples, material with a high natural relative permittivity property value of 9 or greater is used and material with a high natural relative permeability property value of 9 or greater is used. A variety of manufacturing techniques may be used to assemble the inclusions into the interstitial material. For machinable interstitial materials, space for the inclusions may be machined into the interstitial material and the inclusions added as the composite is built up one layer at a time. In some implementations, an injection mold can be used to infuse the interstitial material between inclusion materials, in some implementations the composite may be assembled starting from the corners or in layers as the interstitial supports and inclusions are combined into the composite.

Natural high permeability inclusions add significant complexity to the composite design because of the relatively high conductivity and because of lossy natural ferromagnetic resonances. By controlling the size of inclusions, the shape of the inclusion, the concentration of inclusions and by varying the composite filler types and morphology it is possible to control frequency dispersion of complex permeability and permittivity of the composite material. It is also possible to reduce the size of high permeability inclusions while increasing the overall effect on composite permeability by spacing groups of inclusions closely to achieve dielectric enhancement. Inclusions 74 in the example composite shown in FIG. 4A have defined shapes of cylinders and half cylinders.

Referring to FIG. 4B, composite material 80 includes interstitial material 82 and inclusions 84. In one example, the interstitial material has a select relative permittivity property value and the inclusions 84 have a select relative permeability property value. The shapes of inclusions 84 are generally cross shaped. Additional composite material designs are described in detail in U.S. patent application Ser. No. 12/548,937, entitled “Composites for Antennas and Other Applications” and filed on Aug. 27, 2009, the entire contents incorporated herein by reference.

FIG. 5 is top view of an example lens and antenna that may be used to implement various techniques of this disclosure. As seen in FIG. 5, antenna 34 may be a loop-type of antenna, e.g., custom helical antenna, with many turns 90, resulting in high magnetic field (B) versus current (I) characteristics. In some examples, such as in FIG. 5, antenna 34 may have a partial toroidal shape. A partial toroidal shape can minimize the strength of the back lobes. In accordance with this disclosure, antenna 34 is configured to be substantially non-resonant such that far-field signals, i.e., radiated field, are minimized and near-field signals are maximized. In other example configurations, shapes other than a partial toroid may be desirable and are considered within the scope of this disclosure. As seen in FIG. 5, antenna 34 is disposed within lens 26, also depicted as having a partial toroidal shape. Lens 26 has ends 96, 98. In some examples, the loop-type antenna is much shorter than the wavelength generated by the antenna and source.

FIG. 6 is an example sub-wavelength sized element that may be used to implement various techniques of this disclosure. In particular, FIG. 6 depicts one example of a sub-wavelength sized element 28 of transmitter 14 (or sub-wavelength sized element 54 of receiver 16) that can be used to form a near-field lens, e.g., near-field lens 26 of FIGS. 3 and 5. In the example shown in FIG. 6, sub-wavelength sized element 28 is a cube. However, in other examples, sub-wavelength sized element 28 may include other shapes.

In one example, sub-wavelength sized element 28 is a cube resonator. In one specific example, sub-wavelength sized element 28 is a ½″ cube of high permittivity material, (such as AVX Corporation's X7R dielectric material with a relative permittivity >2000, available at www.avx.com), that is partially enclosed within a cup-shaped or open square design of high permeability material. In some examples, the relative permittivity of the dielectric may be greater than 2000, e.g., 10,000 or 100,000. The permeability of the interstitial material is matched, as closely as possible, to the permittivity of the dielectric material. The permeability and the permittivity are matched in order to create a characteristic impedance approximately equal to the characteristic impedance of the material in which the sub-wavelength element is located in (e.g., free space, given by Z₀=√(μ₀/∈₀), or approximately 377 ohms). Thus, waves incident on the cube will not be reflected.

In the specific example shown in FIG. 6, sub-wavelength sized element 28 is hexahedron-shaped and includes metallic plates 92, e.g., copper, which create a capacitance C. The plates can be wrapped with numerous turns of magnet wire 94, which creates an inductance L, thereby resulting in an LC circuit having a resonance at a particular frequency. The resonance frequency of sub-wavelength sized element 28 can be decreased by increasing the permittivity of the block, which increases the value of capacitance C. The resonance frequency of sub-wavelength sized element 28 can be further decreased by increasing the number of turns of wire and/or multiple turns of wire. It should be noted that the plates are optional and other example configurations do not include plates 92.

The resonance frequency controls the effective permeability of the sub-wavelength sized element. The resonance frequency of the sub-wavelength sized elements may be tuned individually, e.g., by changing the size of the brick or cube or other shaped structure, the size of the metallic plates, and/or the number of turns of wire that are wrapped around the plates. In some examples, the resonance frequencies of sub-wavelength sized elements 28 are set so that the index of refraction, permittivity, and permeability can be controlled in each direction in space. In some examples, each sub-wavelength sized element 28 is tuned to a different resonant frequency. In some examples, some of sub-wavelength sized elements 28 may have negative effective permeability and/or permittivity values, i.e., less than zero, while other sub-wavelength sized elements may have positive effective permeability and permittivity values, i.e., greater than zero.

FIG. 7 is a conceptual diagram illustrating a perspective cross-sectional view of an example near-field lens formed of a plurality of sub-wavelength sized elements, in accordance with various techniques of this disclosure. In particular, FIG. 7 depicts a perspective cross-sectional view of the bottom half of near-field lens 26 of FIG. 5. In accordance with various techniques of this disclosure, partial toroidal shaped loop antenna 34 of FIG. 5 can be disposed within lens 26, which includes both the bottom half depicted in FIG. 7 and a top half (not shown for clarity), thereby creating a partial toroidal shaped lens 26. In other examples, lens 26 and antenna 34 may comprise other shapes, depending upon the desired application. Near-field lens 26, formed of a plurality of sub-wavelength sized elements 28 (FIG. 6), is disposed about, e.g., surrounds, antenna 34 of FIG. 5, thereby forming near-field lens and antenna device 102 of FIG. 5. This design of near-field lens 26 and antenna 34 better captures the near-field signals generated by antenna 34 via source wires connected to a power source (not depicted). By surrounding the antenna with sub-wavelength sized elements, the near-field is captured close in to the antenna so that the near-field can be controlled and shaped immediately after it is generated by a loop.

Although as described above as cubes, sub-wavelength sized elements 28 may be other shapes. In some example configurations, near-field lens 26 may include multiple lens layers (not depicted) such that there are multiple layers of sub-wavelength sized elements 28. In one example configuration (not depicted), near-field lens 26 includes sub-wavelength sized elements 28 within the turns of antenna 34.

As indicated above, antenna 34 and near-field lens 26 generate, focus, and project near-field energy toward an object, e.g., a target and/or remote receiver 16. In other examples, the object may include, but is not limited, to an improvised explosive device, a warhead with electronic fuzing, a vehicle, e.g., an unmanned aerial vehicle, a robot, a car, a motorcycle, a train, airplane, spacecraft, projectiles such as bullets and the like, and equipment comprising electronics, e.g., front-end and back-end electronics of a target.

In a typical loop antenna without sub-wavelength sized elements, such as shown in FIG. 5, a magnetic field is formed around each loop, and these magnetic fields close very near to the loop. However, by using the techniques of this disclosure, the sub-wavelength sized elements of the lens wrapped around antenna 34 prevent the magnetic fields around the loops of the antenna from closing near the loop. In particular, the sub-wavelength sized elements, e.g., sub-wavelength sized element 28 of FIG. 6, capture the near-field energy of the magnetic fields and bend, turn, and project the near-field energy to implement various techniques described in this disclosure. For example, at the back of the antenna, e.g., the region of the antenna that faces away from a remote receiver, the electromagnetic wave can be bent and turned to project it forward in a direction for optimal energy focusing.

As seen in FIG. 7, lens 26 has ends 96, 98, each of which is surrounded by sub-wavelength sized elements 28. By including sub-wavelength sized elements at the ends of lens 26, the magnetic field generated by lens 26 is controlled in a manner that prevents the magnetic field from closing on itself until the designed range.

In some example configurations, another near-field lens may be included in the near-field of the antenna/lens combination of FIG. 7, which may further focus the near-field energy toward the receiver. In some examples, it may be desirable to operate the near-field lens at a single frequency. For example, a near-field lens may be tuned to operate at 1 kHz. Operating at 1 kHz allows the energy beam to penetrate metal well, for example. In such an example, the near-field energy may be projected forward up to about 300 km.

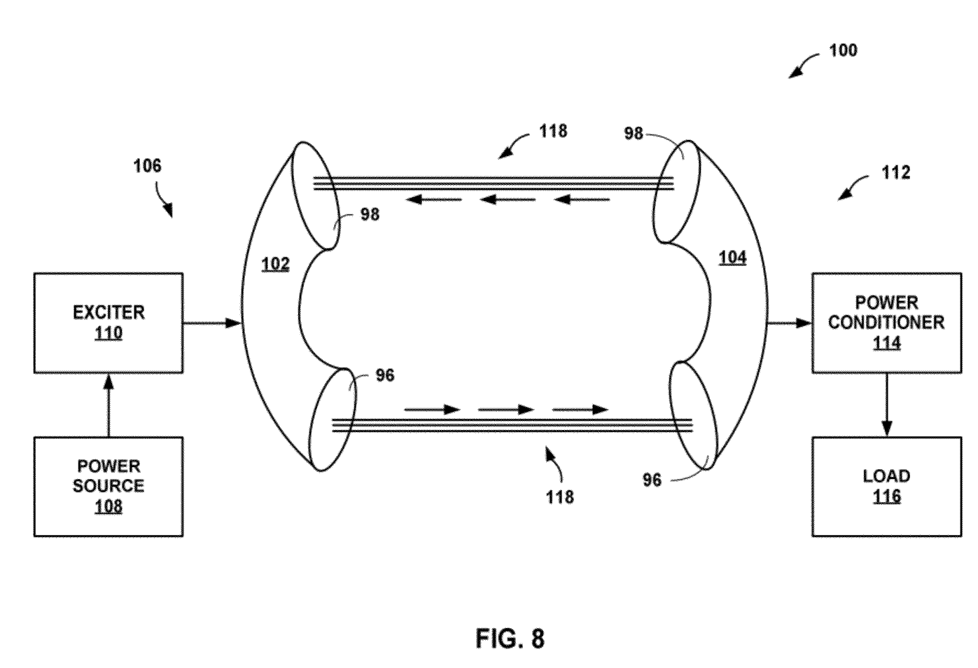

FIG. 8 depicts an example system for wirelessly transmitting near-field energy, in accordance with this disclosure. In FIG. 8, system 100 includes two near-field lens and antenna devices 102, 104 e.g., near-field lens 26 and antenna 34 of FIG. 5. Near-field lens and antenna devices 102, 104 may have partial toroidal shapes, for example. Transceiver 106 includes power source 108, optional exciter 110, and near-field transmitter lens/antenna 102. Transceiver 112 includes near-field receiver lens/antenna 104, optional power conditioner 114, and load 116. It should be noted that in examples described throughout this disclosure, there may be more than one power source 108 and/or more than one near-field lens/antenna 102, 104.

Power source 108, e.g., a battery, fuel cell, generator, capacitor, super capacitor, and the like, generates power which is received by exciter 110. In some examples, power source 108 may provide natural modulation, e.g., 400 Hz aircraft power. Exciter 110 may include, for example, frequency translators, oscillators, mixers, matching circuits, modulators, phase shifters, filters, attenuators, amplifiers, temperature sensors, couplers, and power sensors. Exciter 110 generates an RF signal that induces a current in the antenna, e.g., antenna 34 of FIG. 5, of transceiver near-field lens/antenna 102. Near-field transmitter lens 102 generates near-field energy and re-directs the near-field energy toward an object in the near-field of lens/antenna 102, e.g., near-field receiver lens/antenna 104. The near-field energy transmitted from transceiver 106 is depicted in FIG. 8 as near-field flux lines 118.

Near-field receiver lens/antenna 104 of transceiver 112 receives the near-field energy transmitted from near-field transmitter lens 102, which induces a current in the antenna of transceiver near-field lens/antenna 104. The current induced in the antenna is transmitted to power conditioner 114, which may include, for example, rectifiers, oscillators, amplifiers, synthesizers, power supplies, energy capacitors, regulators, transformers, filters, protection circuitry, and matching circuitry. Power conditioner 114 transmits the conditioner electrical power to load 116.

As seen in FIG. 8, system 100 controls the return of near-field flux 118 from transceiver 112 to transceiver 106 via the design of lens/antenna devices 102, 104, for example. In particular, near-field energy is transmitted from end 96 of lens/antenna device 102 to end 96 of lens/antenna device 104 and the return near-field energy is transmitted back to end 98 of lens/antenna device 102 via end 98 of lens/antenna device 104. This is in contrast to using air or ground as an uncontrolled return path. As such, system 100 intentionally captures the return near-field flux, thereby improving efficiency of the system.

As described above with respect to FIG. 3, in some example configurations, system 100 may be configured such that the focal point may be controlled. In such examples, one or both of transceivers 106, 112 may include a near-field conditioning element, e.g., near-field conditioning 40 of FIG. 3, and a near-field processing element, e.g., near-field processing 44 of FIG. 3, to control the focal point of one or both of lens/antenna devices 102, 104.

Using the techniques described above, energy can be transmitted wirelessly from a transmitter to a remote receiver. Such wireless energy transmission has many applications. For example, the system described above can be used to provide power to remote locations without the cost and infrastructure associated with overhead or underground transmission lines, as shown and described above with respect to FIG. 1.

In another example, the system described above can be used as a directed energy weapon. The antenna and lens described above can focus high energy, low frequency near-field waves into a small region for offensive and defensive applications, e.g., ground-based defense of incoming threats. In one application, the techniques of this disclosure can be used to disable safed or armed electronic detonators in weapons; defeat improvised explosive devices (IEDs) or damage the back-end electronics of targeted equipment or weapons.

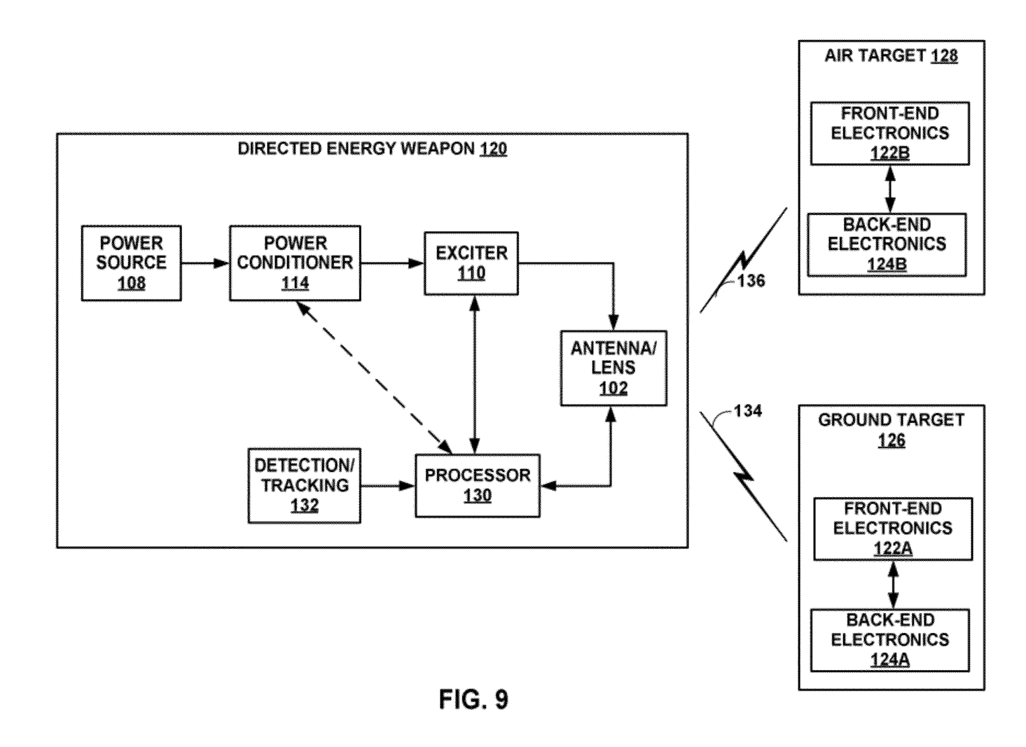

FIG. 9 is a block diagram illustrating an example directed energy weapon using various techniques of this disclosure. Directed energy weapon 120 may be used to damage the electronics, e.g., front-end electronics 122A, 122B (collectively “front-end electronics 122”) and/or back-end electronics 124A, 124B (collectively “back-end electronics 124”), of ground target 126 and/or air target 128 such that targets 126, 128 are no longer a threat. It should be noted that ground target 126 includes both land and sea targets.

Directed energy weapon 120 includes power source 108, power conditioner 114, exciter 110, and antenna/lens 102, each of which was described above and, for purposes of conciseness, will not be described again. Directed energy weapon 120 also includes processor 130 for system control and detection/tracking unit 132 for detection and tracking of incoming threats. Detection/tracking unit 132 may include radar capabilities, laser detection and ranging capabilities (“LADAR”), and/or one or more cameras. In some examples, detection/tracking unit 132 may be incorporated into the functionality of antenna/lens 102.

Processor 130 may execute computer-readable instructions that control and process data from detection/tracking unit 132, control and process data to and from antenna/lens 102, and control and process data to and from exciter 110. In some example configurations, processor 130 may monitor power conditioner 114. Processor 130 can include any one or more of a controller, a microprocessor, an application specific integrated circuit (ASIC), a digital signal processor (DSP), a field-programmable gate array (FPGA), or equivalent discrete or integrated logic circuitry. The functions attributed to processor 130 in this disclosure may be embodied as hardware, software, firmware, as well as combinations of hardware, software, and firmware.

The computer-readable instructions may be encoded within a memory (not depicted). The memory may comprise computer-readable storage media such as a random access memory (RAM), read-only memory (ROM), non-volatile RAM (NVRAM), electrically-erasable programmable ROM (EEPROM), flash memory, or any other volatile, non-volatile, magnetic, optical, or electrical media.

Upon detecting a threat from either or both of air target 128 and ground target 126, antenna/lens 102 of directed energy weapon 120 projects forward near-field energy 134 and 136 toward a respective target 126, 128. Near-field energy 134 may damage or destroy either or both of front-end electronics 122B and back-end electronics 124B of air target 128. Near-field energy 136 may damage or destroy either or both of front-end electronics 122A and back-end electronics 124A of ground target 126. It should be noted that, as a safety feature, some example configurations include a detection/tracking system that turns off near-field energy beam 134 if non-enemy targets enter or are about to enter beam 134.

As described above with respect to FIG. 3, in some example configurations, directed energy weapon 120 may be configured such that the focal point of antenna/lens 102 may be controlled. In such examples, directed energy weapon 120 may include a near-field conditioning element, e.g., near-field conditioning 40 of FIG. 3, and a near-field processing element, e.g., near-field processing 44 of FIG. 3, to control the focal point of antenna/lens 102.

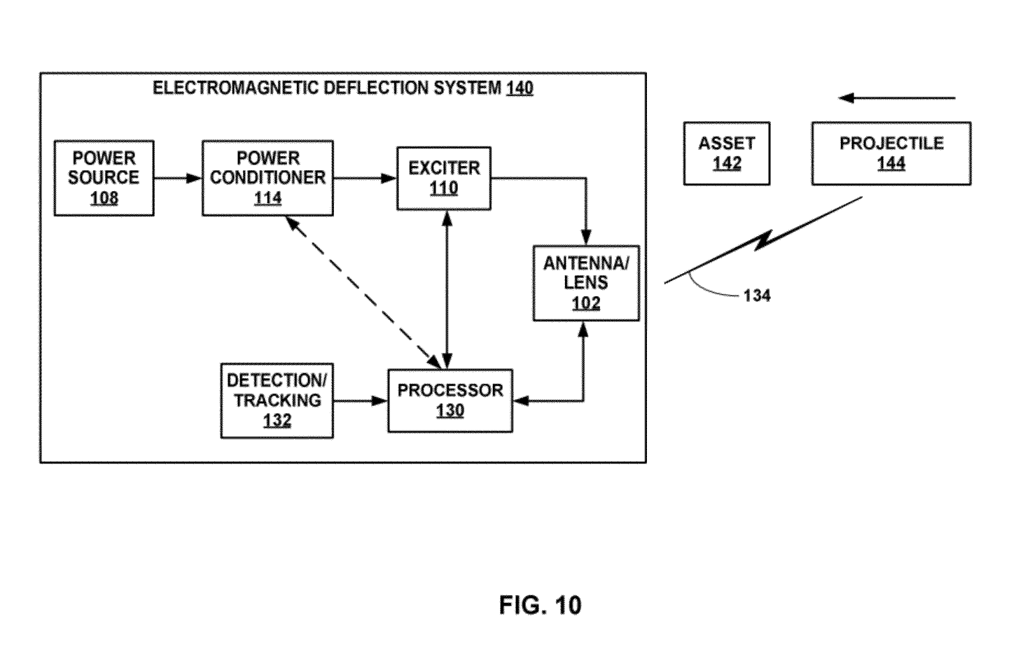

FIG. 10 is a block diagram illustrating an example electro-magnetic deflection system using various techniques of this disclosure. In particular, FIG. 10 depicts a electro-magnetic deflection system 140 that can protect asset 142, e.g., a human, a military base, a military vehicle, from incoming highly electrical conductive projectile 144, e.g., bullets and shrapnel, by detecting and tracking the incoming projectile, and focusing near-field energy 134 on the projectile to cause it to alter its course, e.g., deflect away from asset 142, remove all relative kinetic energy from the projectile, attract the projectile, or turn the projectile and direct it towards any location, including the point of origin. The components of electro-magnetic deflection system 140 are similar to those described above with respect to the directed energy weapon and, for purposes of conciseness, will not be described again.

In accordance with this disclosure, the near-field can be finely controlled. Additionally, in some quasi-magnetostatic applications where one or multiple fields are changing slowly compared to other fields, the phase and direction between the total electric and magnetic fields at any point in space in the near-field may be controlled. The electric field induces a surface current on a conductive object, which creates a corresponding magnetic field on the conductive object. The surface current is intentionally induced to create a magnetic field opposed or aligned with an incident magnetic field in order to attract or repel the conductive object.

Without being bound by theory, an example electro-magnetic deflection calculation is provided as follows. Assume that an object has a length of 54 millimeters, length of 14 millimeters, a mass of 42.4 grams, and a velocity of 923 meters/second (m/s). The object will travel 10 meters in 10.83 milliseconds (ms). In order to deflect the object 6 feet in a direction perpendicular to the path of the object, an acceleration of 3.116×10⁴ m/s² is required (by solving d=½*a*t² for acceleration a, where d=6 feet (1.83 meters), and where t=10.83 ms).

Acceleration is equal to force divided by mass, thus the force equals 3.116×10⁴ m/s² times 0.0424 kilograms, or 1321 Newtons. The force can be used to calculate the required magnetic and electric fields using the Lorentz force law, which relates the electric and magnetic forces as follows:

F=∇(m·B), (1)

where F is the force on the object, e.g., shrapnel, in Newtons, m is the magnetic dipole moment in ampere-square meters, B is the magnetic field in teslas, and where bold face type in Eq. (1) denotes vector quantities. It should be noted that the “·” in Eq. (1) denotes the dot product and ∇ denotes gradient operation.

In addition, the magnetic dipole moment for a small current loop is:

m=IA (2)

where m is the magnetic dipole moment of the object, e.g., shrapnel, in ampere-square meters, A is the area over which the current loop flows where the direction of A is normal to the area defined by the right hand rule, I is the current in amperes and where bold face type in Eq. (2) denotes vector quantities.

Current density is given by the following equation:

J=σE, (3)

where J is the current density in amperes/meter², σ is the electrical conductivity of the shrapnel in Siemens/meter, and E is the electrical field in volts/meter, and where bold face type in Eq. (3) denotes vector quantities. Integration of the surface currents provides the overall current in a region under control.

Assuming that the bullet is made of brass having an electrical conductivity σ=15*10⁶ (Siemens/meter), by conservatively substituting J=σE for I in Eq. (2) above, Eq. (1) can be rewritten as the following:

F=∇(σEAB cos(θ)). (4)

For B=10⁻³ Teslas, θ=0 degrees and assuming the expression changes linearly with space in a unitary way, field intensity, E, equals 117 Volts/meter. In this manner, electro-magnetic deflection system 140 of FIG. 10 can calculate and generate electromagnetic fields that, when projected via antenna/lens 102, can deflect projectile 144 away from asset 142. A similar calculation may be performed to determine an electromagnetic field that can attract, stop, maglev, return, despin, or deflect a copper jet from a shaped charge, fire, vehicle, etc. Multiple targets or multiple portions of a target system may be deflected via a tracking system combined with a near-field deflection system capable of independent force control over multiple targets or multiple portions of a target to control up to all degrees of freedom of an object.

In another example, the techniques described above can be used for remotely powering robots, tools, unmanned aerial vehicles (UAVs), etc. In other example implementations, the techniques described above can be used to provide emergency remote power to cities, ailing aircraft, etc., provide long range high power magnetic levitation (“maglev”) capabilities to vehicles, e.g., motorcycles, cars, trains, rockets, aircraft, etc., and provide low-cost continuously tunable coherent light source/modulator.

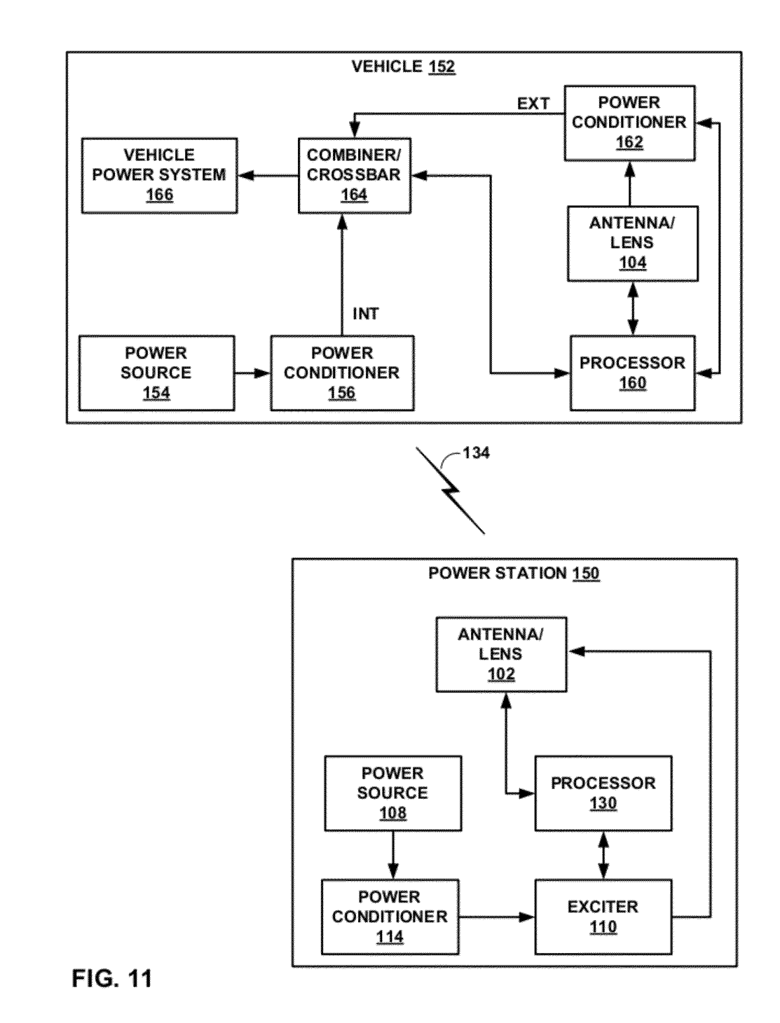

FIG. 11 depicts an example system for remotely powering a vehicle using various techniques of this disclosure. The system shown in FIG. 11 includes power station 150 and remote vehicle 152. Power station 150 includes power source 108, power conditioner 114, exciter 110, processor 130, and antenna/lens 102, each of which having been described above and, for purposes of conciseness, will not be described again. Antenna/lens 102 is configured to capture near-field signals, generate near-field energy, and re-direct near-field energy 134 toward an object in the near-field of the lens, namely vehicle 152.

Vehicle 152 is normally powered via internal power source 154. However, if power source 154 is unable to deliver power, or if vehicle 152 needs power in addition to that supplied by power source 154, then vehicle 152 may receive near-field energy from power station 150 via antenna/lens 104. In particular, power station 150 generates near-field energy, and re-directs the near-field energy 134 to vehicle 152. Vehicle 152 and, particularly, antenna/lens 104, receives the transmitted near-field energy. The received near-field energy induces a current in the antenna of antenna/lens 104, which is transmitted to power conditioner 162 for conditioning. The conditioned power is transmitted to combiner/vehicle crossbar 164. Combiner/vehicle crossbar 164 combines the internal power from power source 154 via conditioner 156 (if there is internal power available) with the external power received from power station 150 via power conditioner 162. Combiner/vehicle crossbar 164 then supplies power to vehicle power system 166. In addition, the power supplied to vehicle power system 166 may wirelessly power devices in the vehicle, e.g., portable media players, portable computers, and other portable electronic devices, as well as provide power to devices outside of the vehicle, e.g., provide emergency power to another vehicle 152 or another device.

It should be noted that although only a single vehicle was depicted in FIG. 11, there may be multiple vehicles. In addition, configurations may include a plurality of lenses and antennas. Further, this disclosure is not limited to automobile-like vehicles. Rather, vehicle 152 may instead be one or more aircraft, spacecraft, watercraft, trains, motorcycles, robots, battery charger, and the like. Further still, while power station 150 may in some examples be terrestrially-based, in other example implementations, power station 150 may be an orbiting power station, for example, that provides power to satellites, or power station 150 may be based on an extraterrestrial site, e.g., based on the moon, Mars, etc., to provide remote power to objects located on that extraterrestrial site or within the near-field of that extraterrestrial site.

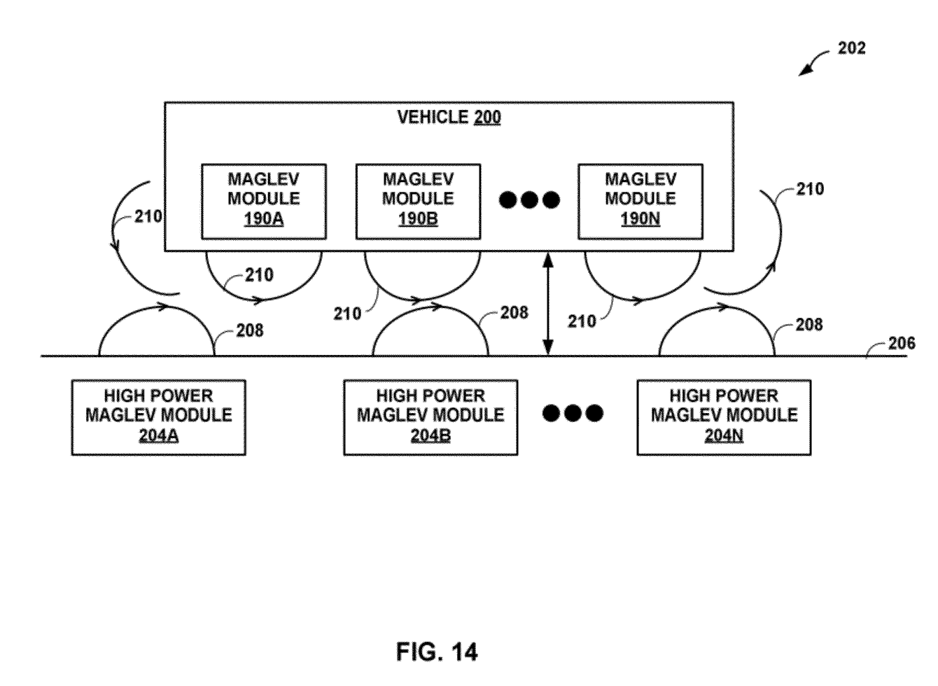

It should be noted that vehicle 152 may be a magnetic levitation vehicle, e.g., vehicle 200 of FIG. 14, and may receive near-field energy 134 for powering its subsystems via antenna/lens 104 of FIG. 11. Received near-field energy 134 may power the components necessary for levitation and propulsion. In some examples, the system of FIG. 11 may be coupled to a system that detects objects that will intersect the near-field beam. The detection system may lower, turn off, or re-route power if the system determines that there is a risk of damaging the object entering the near-field beam. Detection may be accomplished using, for example, radar or optical technologies.

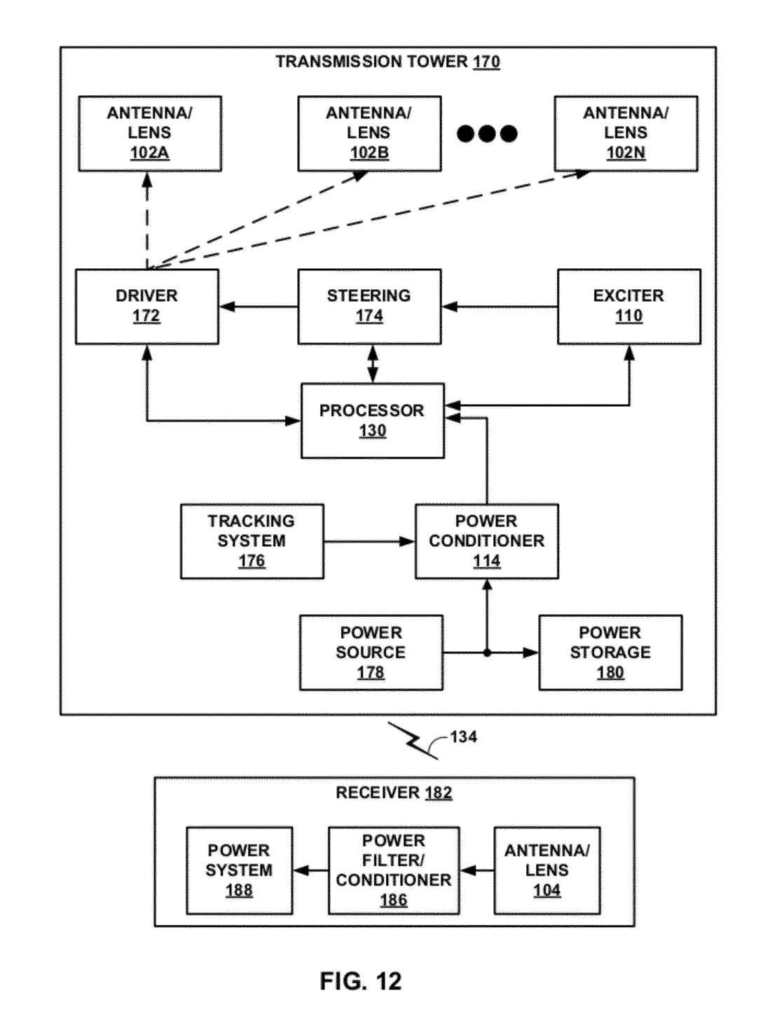

FIG. 12 depicts an example system for remotely powering one or more systems using various techniques of this disclosure. As seen in FIG. 12, transmission tower 170, e.g., transmission tower 12 of FIG. 1, includes antenna/lens devices 102A-102N (collectively referred to herein as “antenna/lenses 102”), each of which being electrically connected to driver unit 172, exciter 110, and steering unit 174. Exciter 110 generates RF energy from a power source. Steering unit 174 controls the direction that each one of antenna/lenses 102 is pointed in order to align the near-field energy beam with the target. Steering unit 174 allows transmission tower 170 to direct near-field energy to multiple objects, e.g., in vehicles, battery charges, or robots, simultaneously in various directions, via antenna/lenses 102. Driver unit 172 boosts the power to sufficient levels. Although depicted as separate units, many of the components shown in FIG. 12 may be combined into a single unit.

Transmission tower 170 further includes tracking system 176, which may include global positioning system (“GPS) capabilities that allow transmission tower 170 to locate each object to which near-field energy can be directed and exclude objects subject to electronic damage. In addition, transmission tower 170 may include power source 178 and power storage 180. In one example, power source 178 may be a diesel generator. Transmission tower 170 converts either alternating current or direct current from power source 178 or power storage 180 into near-field RF signals 134 that are beamed by a near-field RF lens to respective receiver 182 on the object, e.g., vehicles, robots, cities, cellular phones, troops, and other individuals and systems.

Receiver 182, which may be located on, for example, an autonomous, and/or wearable robot, receives near-field RF signals 134 from transmission tower 170 via antenna/lens 104. In some examples, the received energy is filtered and conditioned by power filter/conditioner 186 and delivered to power system 188, from which the load, e.g., a robot, may draw operational power. In one example, power filter/conditioner 186 includes rectification circuitry to convert alternating current to direct current. In another example, power is delivered directly to the load.

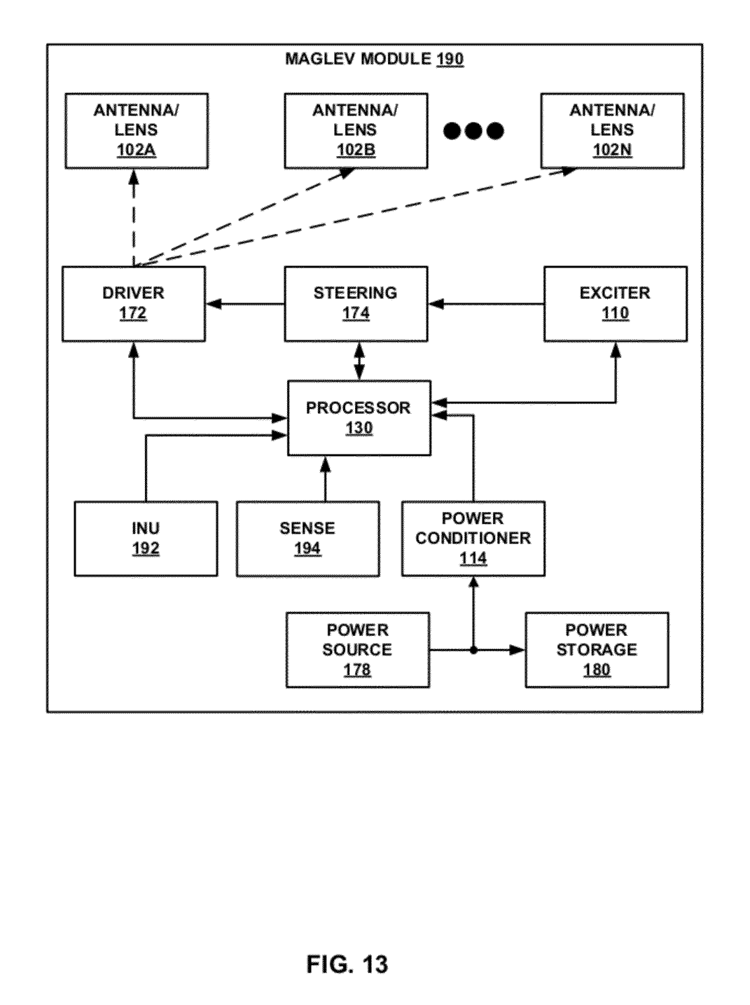

FIG. 13 depicts an example magnetic levitation module for lifting and/or propelling vehicles or objects using various techniques of this disclosure. Example objects include, but are not limited to, vehicles, pallets, etc. As seen in FIG. 13, magnetic levitation (“maglev”) module 190 includes components similar to those described above and, for purposes of conciseness, will not be described again. Maglev module 190 also includes Inertial Navigation Unit (“INU”) 192, which processes data from sensors in communication with sense unit 194 (e.g., GPS, accelerometers, gyroscopes, magnetometers, and the like) to compute current and future location, orientation, and movement vectors (e.g., velocity, acceleration, jerk, etc.) of the object, e.g., vehicle, in which the INU is located. Sense unit 194 detects current magnetic fields, orientation, acceleration, velocity, and the like as input to INU 192. In addition, maglev module 190 includes antenna/lens 102A-102N (collectively referred to herein as “antenna/lenses 102”), each of which being electrically connected to driver unit 172, exciter 110, and steering unit 174. Each antenna/lens 102 may be located at various positions on a vehicle, e.g., car, train, bus, and the like, as necessary to ensure that the vehicle is sufficiently supported, as shown below in FIG. 14.

In addition, maglev module 190 may provide wireless power to devices, e.g., portable media players, portable computers, and other portable electronic devices, in a vehicle associated with the maglev module 190, e.g., vehicle 200 of FIG. 14, as well as provide power to devices outside of the vehicle, e.g., provide emergency power to another vehicle or another device. Further, using electromagnetic deflection techniques described in this disclosure, maglev capabilities can be provided without incorporating related components in the vehicle or unpowered objects, such as a container, bicycle, construction material, etc.

FIG. 14 depicts an example magnetic levitation system for lifting and/or propelling vehicles using various techniques of this disclosure. As seen in FIG. 14, vehicle 200, e.g., car, bus, train, etc., includes one or more maglev modules 190A-190N (collectively referred to as “maglev modules 190”), as described above with respect to FIG. 13, that are positioned at various locations of vehicle 200. System 202 of FIG. 14 further includes one or more high power maglev modules 204A-204N (collectively referred to as “high power maglev modules 204”) positioned under roadway 206, for example. It should be noted, however, that high power maglev modules 204 may be positioned on poles, in arrays, or one or more maglev modules 190 may work against the Earth's magnetic field. Each high power maglev module 204 is electrically connected to a power source (not shown), such as a power generator, battery, capacitor, or solar cell, for example. High power maglev modules 204 include circuitry similar to that described above in FIG. 13 with respect to maglev module 190. High power maglev modules 204 adjust their magnetic fields, shown as flux lines 208, to interact with the magnetic fields of maglev modules 190 of vehicle 200, shown as flux lines 210, thereby causing vehicle 200 to be lifted, lowered, levitated, and propelled forward, backward, and to the side. Processor 130 of maglev module 190 (FIG. 13) automatically controls balance and movement of vehicle 200. Antenna/lenses 102 of maglev modules 190 in vehicle 200 may be configured as a phased array or as multiple single tuned antennas/lenses. It should be noted that maglev module 190 of FIG. 13 may also be configured to receive power using various techniques described above, which, for purposes of conciseness are not depicted in FIG. 13.

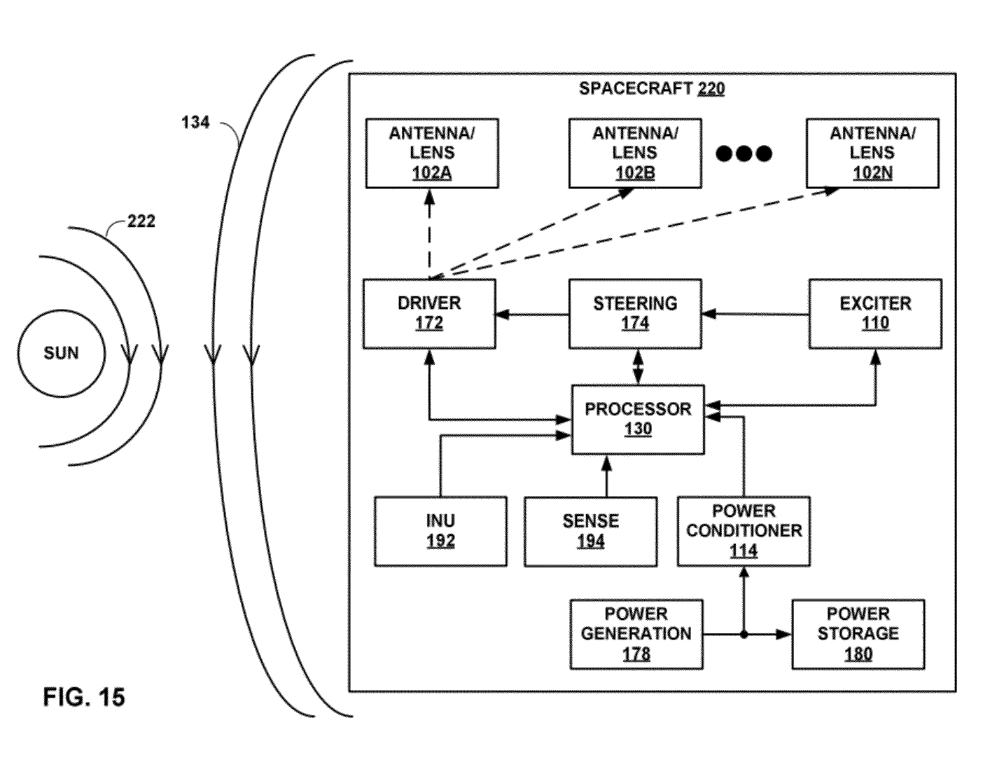

FIG. 15 depicts an example system for producing an artificial magnetosphere using various techniques of this disclosure. In the example system depicted in FIG. 15, spacecraft 220 generates near-field energy 134 via antenna/lenses 102A-102N (collectively referred to herein as “antenna/lenses 102”), in the manner described above. The components of spacecraft 220 are similar to those described above and, for purposes of conciseness, will not be described again. The near-field energy 134 generated by spacecraft 220 opposes the sun's solar wind magnetic field 222 and prevents the solar wind magnetic field 222 from “connecting” to spacecraft 220. This opposition protects spacecraft 220 and any objects, e.g., humans and/or electronics located inside the spacecraft, and may also be used to propel spacecraft 220. In some examples, processor 130 controls a duty cycle to sense solar wind magnetic field 222 to compensate for variability in directions and intensity, or adapt continuous fields automatically for the lowest radiation exposure.

Although described above with respect to a spacecraft, these techniques may be based on a moon or planet, including Earth, to protect objects, e.g., humans, from radiation or highly radioactive environments. Additionally, these techniques can be applied to rockets, vehicles, and humans in space, e.g., humans that are spacewalking.

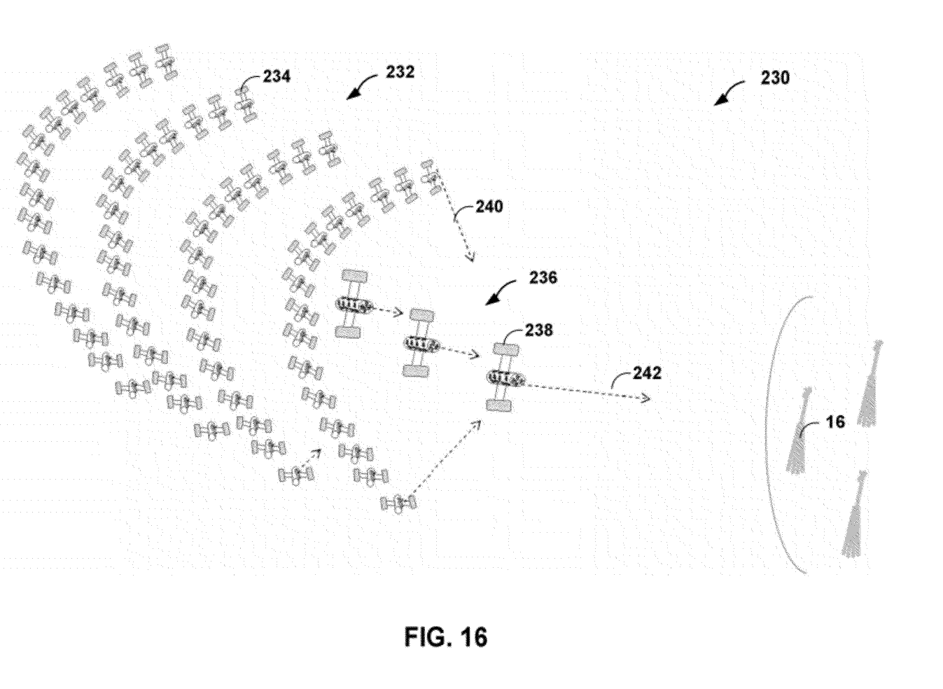

FIG. 16 depicts an example system for providing inter-satellite and space-based power using various techniques of this disclosure. In particular, system 230 includes one a cluster 232 of solar insolation collector satellites 234 and a cluster 236 of Controller-Power Transmission Satellites 238 (CPTS) to generate and transmit near-field energy to other satellites or to remote locations, e.g., a moon, planet, and/or receivers on Earth. Cluster 232 of solar insolation collector satellites 234 may use photovoltaic, concentrator and/or heat converters to generate DC power. Cluster 232 converts the DC power to AC power, and translates the AC power to a frequency in the range of 1 KHz to 1 MHz, where low frequencies increase the range for power delivery. Cluster 232 converts the electrical current at this frequency to near-field RF energy using the various techniques described above and transmits the near-field RF energy 240 to the cluster of controller-power transmission satellites (CPTS). Each CPTS may translate the received RF power to a higher frequency, e.g., 30 MHz to 250 MHz, near-field RF power, and transmit the near-field RF power 242 to sub-wavelength sized receivers 16 on Earth or any other celestial body such as another planet or a moon of a planet or spacecraft. This concept can be an alternative to the current space power transmission techniques that utilize laser and very low frequency RF, e.g., much less than 1 kHz, suitable for efficiently penetrating the ionosphere.

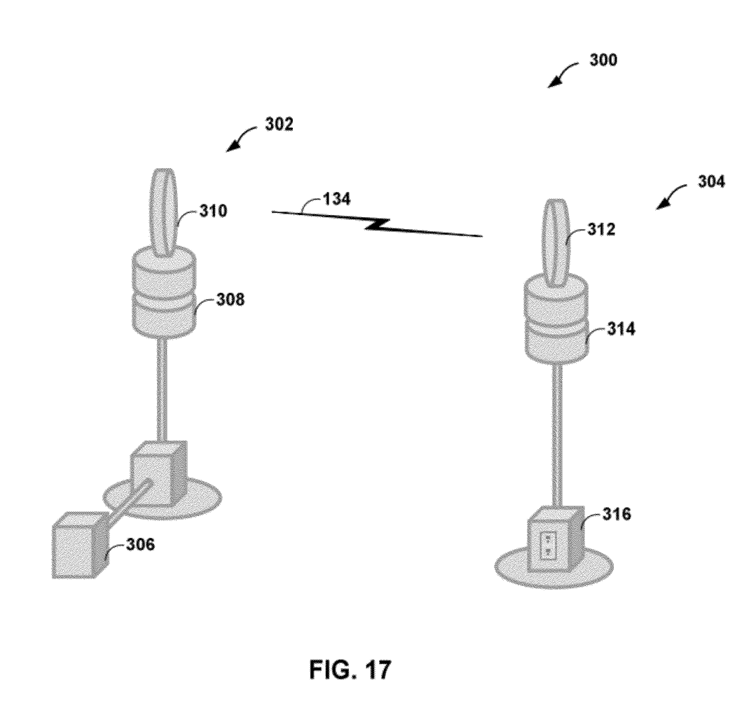

FIG. 17 depicts an example wireless power extension system using various techniques of this disclosure. In particular, wireless power extension system 300 includes transmitter 302 that generates and transmits near-field energy, and receiver 304 that receives the transmitted near-field energy. Transmitter 302 is connected to power source 306. Transmitter 302 converts, via frequency translator 308, the alternating current or direct current from power source 306 into near-field energy 134 that near-field RF lens/antenna 310 transmits to receiver 304. In particular, near-field RF lens/antenna 312 of receiver 304 receives near-field energy 134 from transmitter 302. The received near-field signal is converted, via frequency translator 314, to either direct current or alternating current, which is directed to electrical outlet 316 to supply power. In this manner, system 300 wirelessly provides power across a distance and, as such, is a wireless power extension system.

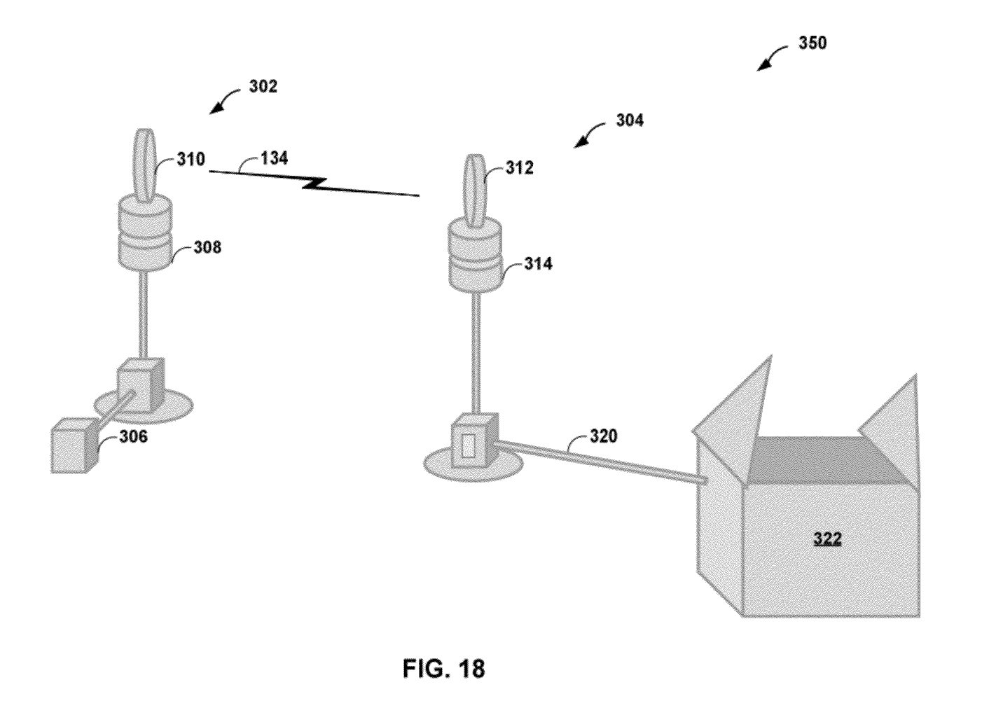

FIG. 18 depicts an example wireless power temporary hookup system using various techniques of this disclosure. In particular, wireless power temporary hookup system 350 includes transmitter 302 that generates and transmits near-field energy, and receiver 304 that receives the transmitted near-field energy. Transmitter 302 is connected to power source 306. Transmitter 302 converts, via frequency translator 308, the alternating current or direct current from power source 306 into near-field energy 134 that near-field RF lens/antenna 310 transmits to receiver 304. In particular, near-field RF lens/antenna 312 of receiver 304 receives near-field energy 134 from transmitter 302. The received near-field signal is converted, via frequency translator 314, to either direct current or alternating current. The current is transmitted via cable 320 to provide temporary power to, for example, tools used in new construction 322. The generated current provides a source of temporary power in the sense that it will eventually be replaced with a permanent power source, e.g., via underground or overhead power cables. Of course, numerous other uses of temporary power are possible and considered within the scope of this disclosure.

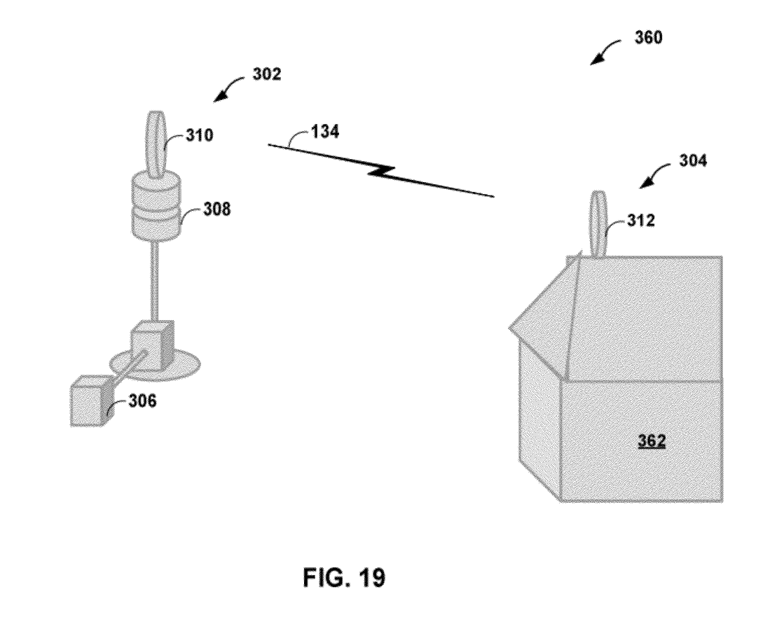

FIG. 19 depicts an example wireless power replacement system using various techniques of this disclosure. In particular, wireless power replacement system 360 may be used to permanently replace underground power lines and overhead power lines. System 360 includes transmitter 302 that generates and transmits near-field energy, and receiver 304 that receives the transmitted near-field energy. Transmitter 302 is connected to power source 306, e.g., a transformer substation. Transmitter 302 converts, via frequency translator 308, the alternating current power source 306 into near-field energy 134 that near-field RF lens/antenna 310 transmits to receiver 304. In particular, near-field RF lens/antenna 312 of receiver 304 receives near-field energy 134 from transmitter 302. The received near-field signal is converted to either direct current or alternating current that is line transmitted to a service panel in building 362. The generated current provides a source of permanent power in the sense that no underground or overhead power cables need to be provided at a later date.

In addition to the devices and systems described above, this disclosure is also directed to methods of transmitting, receiving, repeating, and re-transmitting near-field energy. The method of transmitting, for example, includes generating a radiofrequency (RF) signal, e.g., via power source 108 and exciter 110 of FIG. 8, generating near-field signals from the RF signal, e.g., via the lens and antenna of FIG. 5 comprising sub-wavelength sized elements 28 disposed about the antenna, capturing the near-field signals, generating near-field energy, and re-directing the near-field energy toward an object in the near-field of the lens.

Various aspects of the disclosure have been described. These and other aspects are within the scope of the following claims.

1. A device for transmitting near-field energy, the device comprising:
at least one source that generates a radiofrequency (RF) signal;
an antenna that generates near-field signals from the RF signal; and
a plurality of sub-wavelength sized elements that form a lens in communication with the antenna that captures the near-field signals, generates near-field energy, and re-directs the near-field energy toward an object in the near-field of the lens,
wherein the sub-wavelength sized elements are disposed about the antenna.

2. The device of claim 1, wherein the sub-wavelength sized elements comprise metamaterial elements.

3. The device of claim 1, wherein the sub-wavelength sized elements comprise composite materials.

4. The device of claim 1, wherein the sub-wavelength sized elements comprise composite materials and metamaterials.

5. The device of claim 1, wherein the antenna is a loop antenna comprising a plurality of turns.

6. The device of claim 1, wherein the lens and the antenna form a partial toroidal shape.

7. The device of claim 1, wherein the antenna is a first antenna, the lens is a first lens, and wherein object is a receiver comprising:
a plurality of sub-wavelength sized elements that form a second lens that captures the transmitted near-field energy; and
a second antenna in communication with the second lens that generates a current from the near-field energy.

8. The device of claim 1, wherein the lens forms part of either a first magnetic levitation module or an electromagnetic deflection system.

9. The device of claim 1, wherein the object is a moving and electrically conductive, and wherein the near-field energy alters the course of the object.

10. The device of claim 8, wherein the device is configured to produce an artificial magnetosphere.

11. A device for receiving near-field energy, the device comprising:
a plurality of sub-wavelength sized elements that form a lens that captures the near-field energy; and
an antenna in communication with the lens that generates a current from the near-field energy,
wherein the sub-wavelength sized elements are disposed about the antenna.

12. The device of claim 11, wherein the generated current provides a source of temporary power.

13. The device of claim 11, wherein the generated current provides a source of permanent power to a structure.

14. The device of claim 11, wherein the device is a part of a magnet levitation module.

15. A system for wirelessly transmitting near-field energy, the system comprising:
at least one source that generates a radiofrequency (RF) signal;
a first antenna that generates near-field signals from the RF signal;
a first plurality of sub-wavelength sized elements that form a first lens in communication with the antenna that captures the near-field signals, generates near-field energy, and re-directs the near-field energy into the near-field of the first lens,
wherein the first plurality of sub-wavelength sized elements are disposed about the first antenna;
a second plurality of sub-wavelength sized elements that form a second lens that captures the transmitted near-field energy; and
a second antenna in communication with the second lens that generates a current from the near-field energy,
wherein the second plurality of sub-wavelength sized elements are disposed about the second antenna.

16. The system of claim 15, wherein the sub-wavelength sized elements comprise metamaterial elements.

17. The system of claim 15, wherein the sub-wavelength sized elements comprise composite materials.

18. The system of claim 15, wherein the sub-wavelength sized elements comprise composite materials and metamaterials

19. The system of claim 15, wherein the antenna is a loop antenna comprising a plurality of turns.

20. The system of claim 15, wherein the lens and antenna form a partial toroidal shape.

21. The system of claim 15, wherein the first lens forms part of a power station, and wherein the second lens forms part of a vehicle or battery charger.

22. The system of claim 15, wherein the first lens forms part of a transmission tower, and wherein the second lens forms part of a receiver.

23. The system of claim 15, wherein the first lens forms part of a first magnetic levitation module, and wherein the second lens forms part of a second magnetic levitation module.

24. The system of claim 15, wherein the first lens is positioned on a satellite orbiting Earth, and wherein the second lens is positioned on a tower on Earth.

25. The system of claim 15, further comprising an electrical outlet, wherein the generated current is directed to the electrical outlet to supply power.

26. A directed energy weapon that transmits near-field energy, the weapon comprising:
a source that generates a radiofrequency (RF) signal;
an antenna that generates near-field signals from the RF signal; and
a plurality of sub-wavelength sized elements forming a lens in communication with the antenna that captures the near-field signals, generates near-field energy, and re-directs the near-field energy toward an object in the near-field of the lens,
wherein the plurality of sub-wavelength sized elements are disposed about the antenna.

27. The weapon of claim 26, wherein the object is a ground-based target.

28. The weapon of claim 26, wherein the object is at least one of an improvised explosive device, a warhead with electronic fuzing, a vehicle, spacecraft, and equipment comprising electronics.
